(19) United States
(12) Patent Application Publication
(10) Pub. No.: US 2004/0163494 A1
(43) Pub. Date: Aug. 26, 2004

(54) Opener for variety of ring-pull containers

(76) Inventors: Brian Alexander, Croydon (GB); Carl Ernest Alexander, London (GB)

Correspondence Address: Maxim H Waldbaum, Salans, 620 Fifth Avenue, New York, NY, 10020, US

(21) Appl. No.: 10/482,945

(22) PCT Filed: Jul. 5, 2002
(86) PCT No.: PCT/GB02/03093

(30) Foreign Application Priority Data
Jul. 9, 2001 (NZ) 512856
May 24, 2002 (NZ) 519165

(51) Int. Cl. B67B 7/16

(52) U.S. Cl. 81/3.55

(57) ABSTRACT

A tool for opening a container sealed by a ring-pull seal is described. The hand-operated tool saves overloading a person's hands by gripping the ring-pull or tab, and manipulating the tab in a first direction so that the seal is broken, and then in a second direction so that the tab is laid flat or perhaps removed. For tabs with a large ring, there is a ring engaging means placed in relation to an adjacent sharp tool edge for pressing against the region of the frangible seal in order to initiate breaking of the seal, and a fulcrum or heel on which the tool can be rocked in order to lift the lid away. For beverage containers with smaller tabs the tab itself breaks the seal after being levered by the hand-operated tool.

This invention relates to hand-operated opening devices for engagement with and opening of a seal on a container, generally a container having a metal seal, and more particularly the invention relates to devices for opening containers sealed with ring-pull seals.

The technology for making easily openable metal cans has evolved considerably over the years with recent trends being in the areas of materials minimisation, cost-effective containers, simple sealing means, and so on. One development has been the frangible seal equipped with a single-use handle; commonly known as the ring-pull can top. In this seal, a circular cut made part-way through the lid of the can is stamped into but not through the lid and comprises a frangible seal. A break initiating means is formed by welding a rigid handle on to the lid at a point adjacent to a part of the cut. On being held and bent upward by hand pressure, the rigid handle forces an interior part of the cut downward below the rim of the can. This action (which may be focused by an extension of the ring pull) exceeds the yield strength of the frangible seal material at that point, causing the seal to burst open. Further pulling on the ring which typically comprises the handle causes the remainder of the lid to be torn away from the rim of the can and hence exposes the contents for use. This is effective, cheap to make, and does not require a tin opener. An increasing number of commodities are now sold in ring-pull cans and it may be that the old-fashioned shearing type tin-opener may become obsolete.

Although the intention of the designers of the ring pull appears to have been to provide a seal that can be opened without any special tool, this goal has only partially been met. Many people find it relatively difficult to open a ring pull without an additional implement. Unfortunately some persons cannot develop the necessary physical force to be applied to the handle. The physical force may damage finger nails, fingers, as well as joints of arthritic people and carpal tunnels and tendon sheaths of people with occupational over-use syndrome in their forearms. Persons with wasting diseases (such as multiple sclerosis) or some neurological diseases including cerebral palsy and the degenerative diseases such as Alzheimer's or Parkinson's wish to enjoy as much independence as possible. Workers in a commercial food preparation unit, including bars and the like may be required to open ring pull cans many times a day hence are exposed to risk of repetitive strain injury.

There appears to be a loose standard for ring pull dimensions and most if not all ring pulls fall into either the finger-accepting large ring class, as used to initiate a wide opening through a frangible seal into a tin container of food, or the smaller width of ring (commonly called a “tab”) used to make an aperture for drinking or pouring purposes through a frangible seal on a beverage can or similar.

The problem to be solved might be described as “provision of a convenient tool to facilitate the removal of a ring pull or tab seal”.

According to the invention, there is provided a can opening device comprising:

a base having a wedge portion at one end and a handle at an opposite end;

a ring pull gripping device mounted on the wedge portion and arranged to grip the ring pull when the wedge portion is inserted beneath the ring pull.

The invention provides an improved tool to aid in the opening and removal of a lid having a ring pull, otherwise known as a tab seal. The tool is for breaking the seal and for pulling the lid off the container. The tool takes the load which is otherwise concentrated by the ring or tab on a small part of the tip of one or two fingers, and spreads it over the user's hand by means of the handle.

The ring pull gripping device enables the ring pull to be bent in a first direction so that the seal is broken, and then bent in a second direction so that the tab is removed, and so that a person's hands are not unduly stressed by the procedure of opening the container.

Preferably, one end of the base defines a first pivot point about which the device can be pivoted to lift the ring pull. This lifting of the ring pull tends to urge the front of the ring pull downwardly, so as to break the seal between the lid and the container. This is the bending in the first direction as discussed above.

The opposite end of the base preferably defines a second pivot point about which the device can be pivoted to lift the lid attached to the ring pull. This is the bending in the second direction as discussed above, which lifts the lid from the container. This second pivot point may be defined by an extension from a surface of the base.

The base may define a raised side wall around the wedge portion for locating the ring pull after the wedge portion is inserted beneath the ring pull. This locates the device with respect to the can.

Preferably, the handle extends upwardly from the base, for example at 30-60 degrees to the base. This places the handle in a convenient position above the can, and gives space for it to be pivoted downwardly, about the second pivot point, which can be defined by the bend between the base and the handle.

The gripping device preferably comprises a latch member projecting upwardly from the wedge portion. The latch member may have a ramp surface at its front, having regard to the direction of insertion of the wedge portion beneath the ring pull, and a recess at is back. As the wedge portion is inserted beneath the ring pull, an edge of the ring rides up the ramp. This tends to urge the opposite side of the ring pull downwardly, which may be sufficient to break the seal. If the seal is not broken, the ring pull can be lifted further by pivoting about the first pivot point.

The height of the latch member above the base is such that the ring pull is elastically deformed for self-engagement with the latch member when the wedge portion is inserted beneath the ring pull. Thus, after the ring pull has risen up the ramp, it drops elastically for engagement with the recess.

The ring pull gripping device is preferably for gripping a first size of ring pull, and a second engagement device is provided for engaging with a second size of ring pull. This second engagement device may comprise a slot for receiving the handle of the second size of ring pull.

This second size of ring pull may be typified by lack of inclusion of a finger hole (and is known as a beverage can tab). The slot is then capable in use of making secure yet releasable engagement with the second size of ring pull. The device of the invention is then also suitable for opening beverage-style ring-pull cans. This slot may be provided in the handle (in which case the wedge end of the device functions as the handle) or in the wedge portion (in which case the same handle can be used).

The second size of ring pull may be fed into the leading edge of the slot by a pushing action, so that after the tab has been gripped, a first upwards lifting of the handle of the tool breaks the seal, and then a downwards push of the handle against the rim or the surface of the can pulls the tab away from the remainder of the can. In this way, the tool serves to assist in picking up the end of the tab and then in bending the tab down. Preferably the slot includes tab retaining means so that the freed tab is retained for controlled removal.

The device is preferably a unitary moulded plastics article.

Examples of the invention will now be described in detail with reference to the accompanying drawings, in which:

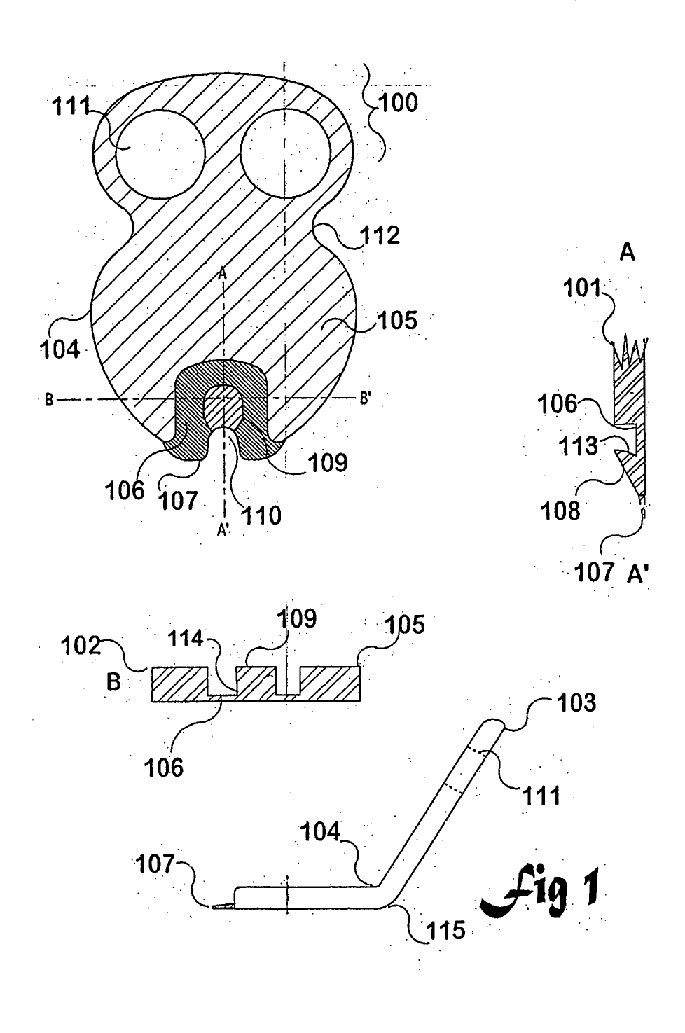

FIG. 1 shows one example of device of the invention;

FIG. 2 shows the device of FIG. 1 with a larger handle;

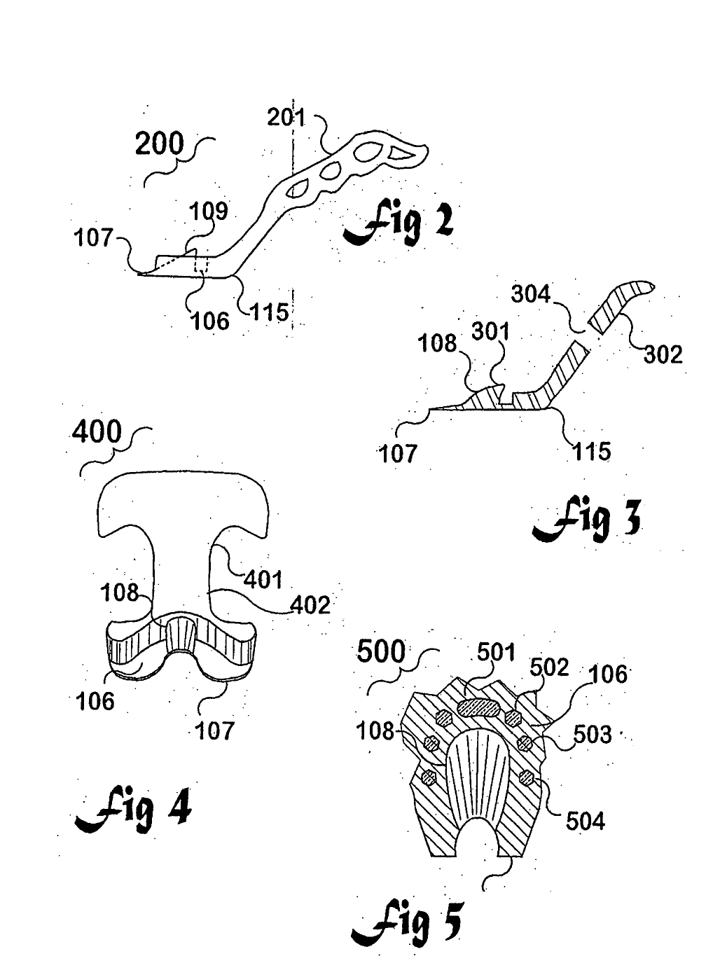

FIG. 3 shows a side view of another example of device of the invention;

FIG. 4 shows another example of device of the invention;

FIG. 5 shows another example of device of the invention made in a thin material, employing a few pillars;

FIG. 6 shows the working end of another example of device of the invention, in plan view;

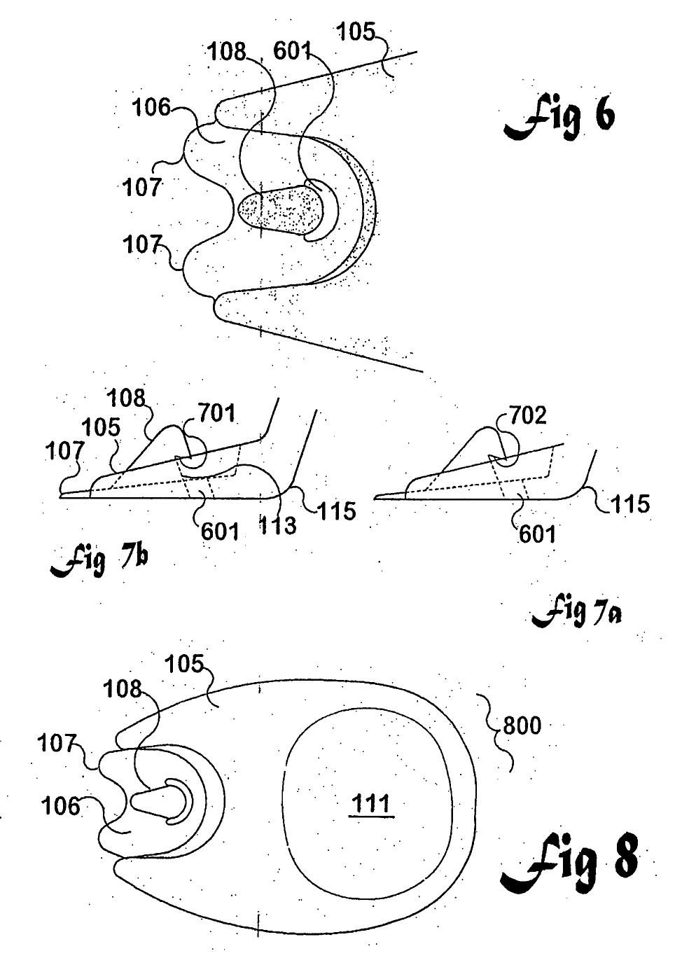

FIG. 7a shows the working end of the device of FIG. 6 in elevation view;

FIG. 7b shows the working end of an improved version of the device of FIG. 6, in elevation view;

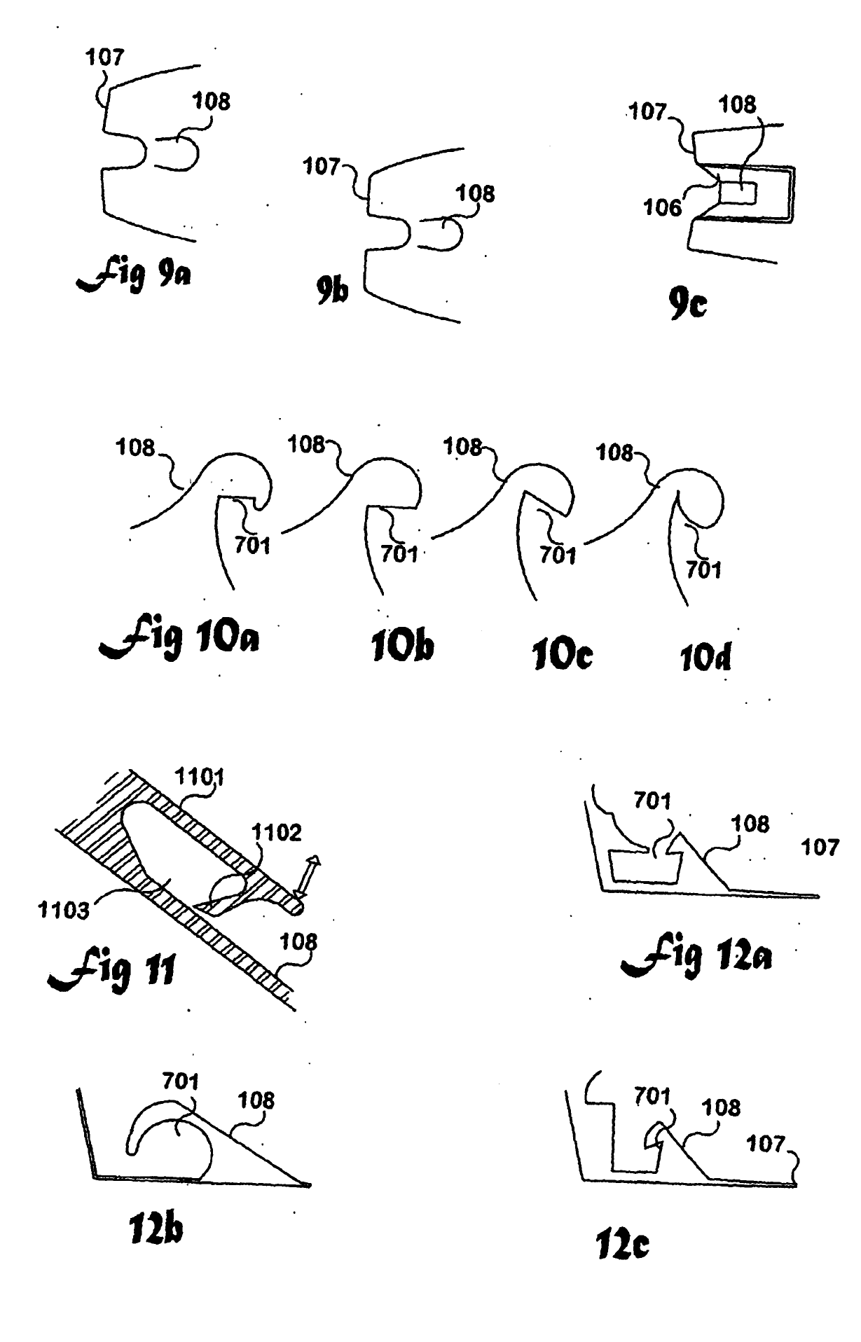

FIG. 8 shows an entire view of the device of FIG. 6;

FIGS. 9a, 9b and 9c show other profiles for the seal-breaking edges of the device;

FIGS. 10a, 10b, 10c and 10d show some other profiles for the part of the device that catches the ring during the seal breaking and lifting steps;

FIG. 11 shows another version of part of the device that catches the ring during the seal breaking and lifting steps;

FIGS. 12a, 12b and 12c show other profiles of the ring ramp and ring catcher;

FIGS. 13a and 13b show a section through another example of the device of the invention using not a bend but an extension to act as a heel;

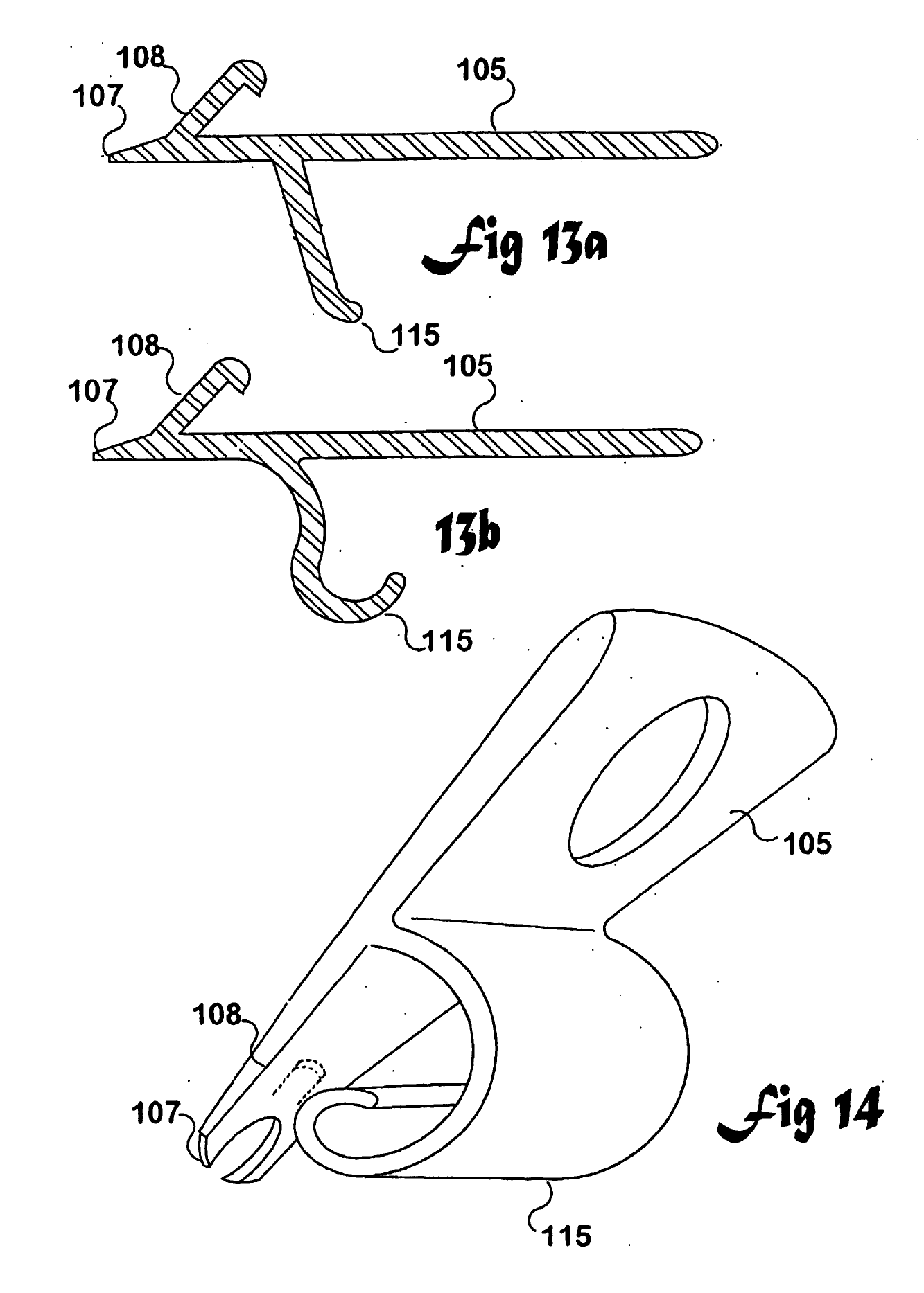

FIG. 14 shows another example of device of the invention, again using not a bend but an extension to act as a heel, in perspective;

FIG. 15 shows another example of device of the invention with a slot in the end of the handle;

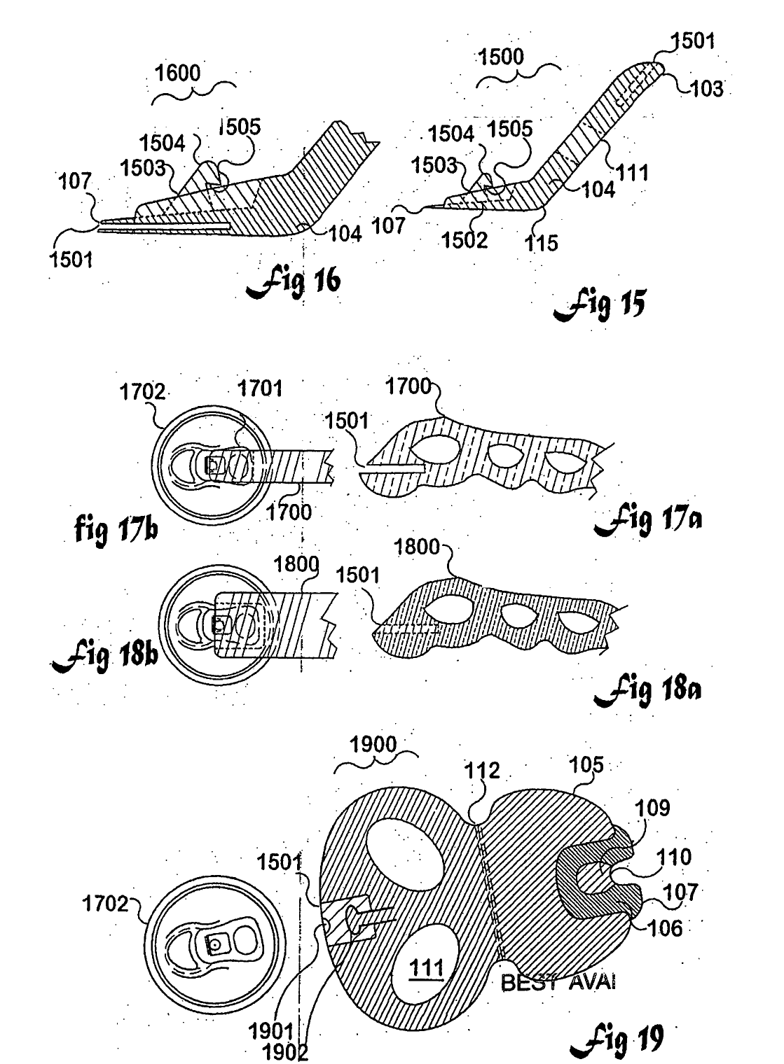

FIG. 16 shows another example of device of the invention with a slot constructed within the head;

FIG. 17a shows a side view of a slot in a narrow handle; open from side to side;

FIG. 17b is a top view of 17a in use on a prior-art can top;

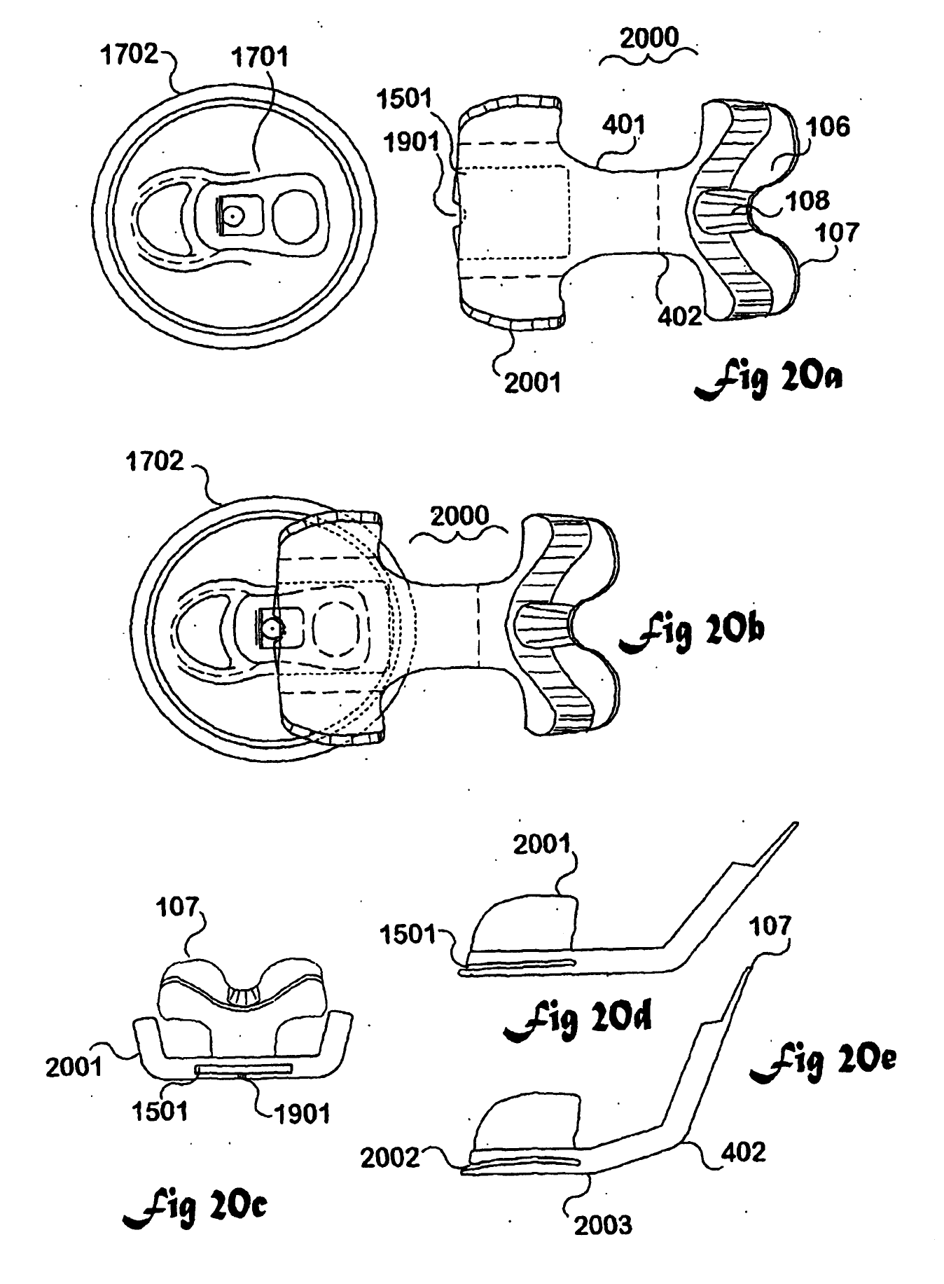

FIG. 18a is a side view of a slot in a narrow handle with a slot enclosed on 3 sides;

FIG. 18b is a top view of 18a in use;

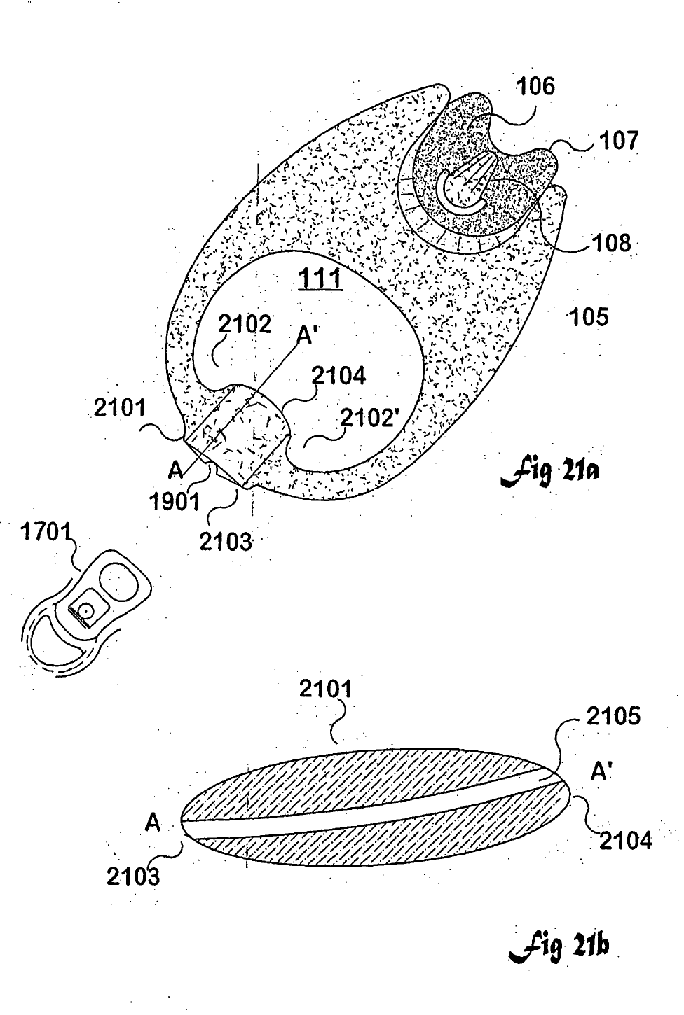

FIG. 19 shows another example of device of the invention which is a dual-ended tool shaped for holding in the palm and including a slot for beverage cans in the handle;

FIGS. 20a-20e show various views of another example of device of the invention;

FIG. 21a shows another example of device of the invention having a flattened portion in the handle including a slot for engagement with a beverage can type ring-pull; and

FIG. 21b is a section through the flattened portion A-A′ of FIG. 21a.

The operation of the device of the invention (the term “device” is used interchangeably with the term “tool” in this description) will first be described with reference to one preferred embodiment, which is that of FIGS. 6 to 8. All embodiments will then be described, concentrating on the differences between them.

As shown in FIGS. 6 to 8, the can opening device has a base with a wedge portion 106,107 at one end, and a handle 800 at an opposite end. A ring pull gripping device 108 is mounted on the wedge portion 106,107 and arranged to grip the ring pull when the wedge portion is inserted beneath the ring pull (namely between the ring pull and the lid of the can).

When the wedge portion 106,107 is inserted beneath the ring pull, the ring pull is lifted up along a ramp surface 105 of the gripping device 108. This bends the ring pull in a first direction, possibly sufficiently so that the seal is broken. If the seal is not broken, the end 107 of the wedge portion can be used as a pivot to lift the ring pull further, and thereby push the opposite end down further to break the seal. Once the seal is broken, the device can be pivoted about the elbow 115 between the base and the handle, so that the ring pull is removed.

The base has a raised side wall defined at the edge of the thicker part 105 for locating the ring pull after the wedge portion is inserted beneath the ring pull.

As mentioned above, the latch member 108 has a ramp surface 105 at its front, and it has a recess 701 at its back. As the wedge portion is inserted beneath the ring pull, an edge of the ring rides up the ramp 105. The height of the latch member 108 above the base is such that the ring pull is elastically deformed for self-engagement with the latch member when the wedge portion is inserted beneath the ring pull. Thus, after the ring pull has risen up the ramp, it drops elastically for engagement with the recess 701.

Thus, in use of the device, a first upwards lifting of the handle of the tool breaks the seal, and then a downwards push of the handle against the rim or the surface of the can while trapping the ring then pulls the seal and lid away from the remainder of the can.

The device of FIGS. 6 to 8 is a unitary moulded plastics article.

The specific construction of the different examples shown in the drawings will now be described in more detail.

A first example is illustrated in FIG. 1, having an hourglass shape 100. This tool is preferably made of a durable and substantially rigid plastics material. The tool includes the major divisions of a handle end (111-112), a preferably bent fulcrum, heel, or base (115), and a ring engagement area (about 106, 108, and 109) at an end farthest from the handle. This example is made form a sheet of plastics material, as a prototype for demonstrating the operation of the device.

The following dimensions are not in any way to be taken as limiting the range or scope of the invention. Some of these dimensions have been determined by the dimensions of a test set of ring-pull sealed cans.

The material is polypropylene with basic thickness=12 mm, width across at the bend 104=67 mm, width across the central land 109=14 mm, and the width of the moat about the central land=5-6 mm. A flattened view of the tool is shown at top left and a profile showing a preferred angle of bending is shown as the view 103. Sections of the ring engagement area cut through the lines A-A′ and B-B′ are shown at 101 and at 102 respectively. The tool is conveniently symmetrical about a vertical axis (A-A′).

This version of the tool includes finger grips—the two holes 111—at one side of a bend at 104, and a waist 112. The “ring grip engagement assembly”, which will now be described in detail, includes a moat 106 which is an area about 5-6 mm wide, thinned to a remaining thickness of about 4 mm, and surrounding three sides of a central ramp or land 109, which rises (as shown in the A-A′ section) from over the sloping surface 108 to about the full thickness of the body of the tool.

Preferred versions are made by moulding in a die, and the high end of the land 109 may then rise well above the general top surface, as shown in FIGS. 2 and 3.

The side walls of the land are optionally recessed to a small extent (see 114), while for some types of ring pull the rear wall (at the high end of the land) is also optionally recessed, though this is not essential. The recess, as shown at 113, may be curved. Indeed, even the other side of the moat may be slightly recessed. The edges of the tool rise gradually from about the leading edges of 107 to the base of the land. Note in particular the “leading edges” 107, which serve in use to push against the frangible seal and assist in breaking the seal, and the space 110 which exists to straddle the “rivet” of the container which is a structure bonding the ring pull to the top of the container. The outer side of the bend 115 (underneath the tool) is a fulcrum, used to convert a downward pressure on the handle area around 111 into an upwards lift of the ring pull for purposes of easier removal of the seal, and the fulcrum is preferably wide enough to be able to span the rim of a narrow can or at least to spread the load over the lid of a large can. The bend should be about 45-50 degrees in order to facilitate the lifting-off of the seal, though other angles may also be satisfactory.

In use, the tool is grasped at the handle end, and made to slide over the top of the container towards the end bearing the ring pull so that the ramp becomes engaged beneath the ring pull. The leading edges are thin enough to get underneath even a flattened-down ring pull and guide the ring pull up on to the ramp as the tool is pushed towards the rim. The sloped ramp 108 of the land 109 causes the ring to rise as the land passes beneath, until the ring falls over the rear of the land and lies in the moat. The ramp (108 in most drawings) and the recess behind (701 in many drawings) are intended to pick up and hold the ring so that when the tip 107 of the tool is pointed downwards to break the seal, the tool is being turned about the firmly held far end of the ring of the ring pull. At this point the tool is held by the ring and if the tool is made to tilt, because of flexibility in the ring pull and its rivet mount, it rotates approximately about the position of the bond between the ring pull and the can. The tool is lifted up at the rear 111 while the container is held (usually vertically) so that the leading edges 107 press increasingly hard against the can surface close to the seal, with the result that the frangible seal becomes fractured. Next, the handle is either simply pulled back tearing the remaining seal, or is pressed down against the top of the can onto the heel 115 thereby (by leverage) raising the land 109 still engaged with the ring pull, which serves to pull the ring seal, together with the lid, away from the remainder of the can. Finally, the removed lid can be grasped and removed from the tool. The waisted shape 112 near the finger grips 111 aids in gripping the tool and may be a sufficient grip even without finger holes 111. Many variations in tool outline are possible as described below.

A second example 200 with a similar gripping end has, instead of finger grips, an elongated handle 201 which may be enclosed within the hand. The version of FIG. 2 is suited for persons who (for example) have arthritic joints and who cannot use the tool by means of the finger holes, or even around the waisted shape, as shown in FIG. 1, without undue pain or risk of injury; an advantage to commercial users. Further, some patients affected by hand injury; stroke for example, have an impaired grip. Note that in this example there is no re-entrant taper beneath the ramp and land 109.

In a third example, an injection-moulded plastics tool may include plastics-saving modifications such as a generally thinner body or a hollowed handle, but with webs or the like, intended for added strength. As shown in the sectional view of FIG. 3, the top of the sloping ramp 109 may be raised above the general tool thickness. Holes 304 may both serve as finger grips and to save the use of plastic materials.

A similar example of device 400 shown in FIG. 4, has a different handle shape 401 This can be held by the fingers and them pressed against the palm.

Instead of providing a moat with completely closed walls as in the examples above, a similar result could be made by simply providing a few posts or short barriers or the like as an intermittent wall. The posts extend upwards from a base plane to a height sufficient to catch the ring pull during use. This height may be about 10 mm and the diameter of each post may be from 3 to 6 mm, depending for example on the mechanical properties of the plastics material used. Use of such posts can reduce the total charge of plastics material required for each tool. FIG. 5 shows a ring engagement area 500 including several such posts (501, 502, 503, and 504) surrounding a central ramp 108.

A tool with a similar gripping engagement assembly can have, instead of finger grips, a bracket section adapted to be affixed to a wall. This version is suited for persons whose manual ability is limited solely to grasping the container and bringing it up against the permanently fixed tool. The angle of the working end should preferably be such that the container is substantially level as the seal is opened, in order to avoid spillage. Being raised at 30-45 degrees is a suitable compromise. A hinge may be included in order that the opened surface remains substantially horizontal.

The fourth example of FIGS. 6 to 8 has already been discussed briefly, and is made of injection moulded polycarbonate. In FIG. 6, the working end is seen in plan view while in FIG. 8 the entire tool 800 is lying on the handle region 111 and because of the bend at the heel 115 the working end is shown at a slant. In FIG. 6, two sharp tongues 107 extend forward and are used to break the seal of the can being opened after the ring pull has been engaged over the end of the ramp 108. The ring is engaged (as in previous examples) by sliding the tool under the ring and towards the edge of the can so that the ring first slides up the ramp 106 and then up over the ramp 108 until it pops over the top and is eventually caught in a notch 701 (FIG. 7a) cut into the rear of the ramp 108 and finishing with the slanted surface 113. Aperture 601 of FIG. 6 is provided for introduction of an injection moulding tool that forms the notch 701 during manufacture of the tool. In FIG. 8, the entire tool is shown, with its handle area 111 made to resemble a typical ring. FIG. 7b shows a preferred design of notch, 702 for use with this tool.

FIG. 9 (as 9a-9c) show different designs for the end of the wedge portion 107 of the base. In each case, a notch is provided which seats around the weld between the ring pull and the lid.

FIG. 10 (as 10a-10d) and FIG. 12 (as 12a-12c) show further variations in relation to the ring-holding part of the tool, where 701 in each case indicates the area which actually retains the ring during use. The “ideal” version may be difficult to specify because there are differences in ring sizes and shapes in the packing industry and field testing is likely to be useful. FIG. 11 shows another solution in section. Here, the part labelled 108 is the part up which the free end of the ring rides as the tool is pushed under the ring and towards the part of the container to be unsealed. The ring continues, displaces the gate 1102, and becomes held within the space 1103 until released after use by upward pressure at the free end of flap 1101. Flap 1101 is given a certain amount of resilience by an appropriate choice of plastics material and flap thickness as is known in the plastics, and the injection moulding industries.

Previous examples (see the side (elevation) view of FIG. 1) are generally flat forms with a bend halfway along giving a heel 115 to serve as a fulcrum along downward pressure on the free end 103 to cause the unsealing end to lift up. In order to explore the benefits of a constant slant applied to the ring and sealed area to be broken, a fifth example explores the use of tools in which a protrusion (115 in FIGS. 13 and 14) runs along the surface of the container so that the working end of the tool (around 107 and including ramp 108 and ring catcher) is always presented at an angle. FIGS. 13a and 13b show sections through two versions of this tool and FIG. 14 is a perspective view of another version in which 105 is a handle.

In this example, the base may be considered to be the wedge portion 107 up to the junction with the extension 115. Thus the base again has a wedge portion 107 at one end and a handle 105 at an opposite end.

The ramp 108 is indistinctly seen through the body of the tool. Of course, other styles incorporating this principle may be made in order to suit selected manufacturing processes.

The tools previously described are not well adapted to handle the smaller, narrower ring pulls (also termed “tabs”) as used on beverage cans, yet a tool of this type would usually be expected to handle those types as well. Often a beverage can tab lies so closely against the lid that people with delicate breakable fingernails, people wearing gloves, or people with large fingers and no nails cannot start the opening process. A typical can top (prior art) is drawn herein as 1702 (in FIGS. 17b and 18b), with a reasonably standardised shape of tab 1701. In general a deep slot is used as a gripping means for a beverage can type of ring-pull or tab although other ways to hold such tabs will be evident to one skilled in the art such as open-sided slots or open-centred slots (edge channels).

The sixth examples of FIGS. 15-21 comprise a deep slot 1501 extending inwards from an edge of the tool, in combination with a leading edge. Preferably the deep slot is close to a lower sliding surface (e.g. 103 in FIG. 15) at least at the opening so that the end of the tab may be easily guided into the slot. At the lower leading edge there is preferably an inflection 1901 of the base capable in use of reaching around the rivet used to hold the ring tab on to the top of the can. After the tab is within the slot, the user simply raises the other end (115-107) of the tool to cause the frangible seal to break by inwards movement of the exposed end of the tab 1701, then lowers the tool to open the aperture, and finally pulls the tool off the tab, perhaps with a “wiping” action pressing the tab downwards during release so that the tab is now laid relatively flat against the top of the can. This solution can be supplied as a tool for use with beverage cans or similar, or in combination with solid food container type ring pull removers as described in other examples in this specification.

FIG. 15 shows a side view of a generic ring puller 1500 with a slot 1501 in the end of the handle and a ramp 1503 for the ring pull on the other end: 1505 indicates a re-entrant ring catch constructed behind the land 1504 (as shown in FIG. 10b for example). FIG. 16 is a side view of the head of a ring puller 1600 with the slot constructed within the head beneath the ramp 1503 and associated land. This placement of the beverage ring pull slot may demand too much strength of plastics used in moulded plastics manufacture. It may for example be constructed of metal for use by professionals in the food industry. Alternatively the narrow plate beneath the slot 1501 in FIG. 16 may be a screwed-on metal plate.

FIG. 17a shows a side view of a slot 1501 in a narrow handle 1700; completely open from side to side, and FIG. 17b shows the handle of 17a in use. This version is easy to make but may have a limited life when in use. FIG. 18a is a similar side view of a slot 1501 in a narrow handle 1800 but to gain more strength from a given amount of plastic the slot is given side walls and is enclosed on 3 sides. This kind of slot may be moulded by a process wherein a tongue is pushed into the molten plastic. Similarly FIG. 18b is a top view of the tool of FIG. 18a in use.

FIG. 19 shows a complete tool 1900 shaped for holding in the palm and including a slot 1501 for beverage can ring pulls in the handle. Optionally, the tool has a bend (in order to provide a fulcrum or “heel”) at about the numeral 112. 1901 is a notch to fit round the rivet on the can. 1902 is an optional catch moulded into the plastic material in order to “trap” the ring pull after (or in case) it is freed from the can so it does not fall out. The catch includes a head for trapping the can at the end of a springy supporting arm, the whole being formed during an injection moulding process. A slightly curved slot (see below) may be a simpler way to grip tabs of various thicknesses. A tapered slot, narrowing towards the back may be easier to mould y using a tapered tongue. The slot may be tapered horizontally, vertically, or in both directions.

FIGS. 20a-e show various views of another shape of device of the invention. This is another complete tool, having a first end (right side in FIG. 20a) adapted for handling ring pulls of food cans and the like with seal breaking edges 107, a ramp up a land 108, and a surrounding moat 106. The second end (left) is adapted for tabs of beverage cans with an internal slot 1501, a rivet recess 1901, as previously described. FIG. 20b shows a beverage can tab 1701 completely inserted into the slot. FIG. 20c shows a front view from the beverage can slot end. This tool has a single bend as shown in the side view FIG. 20d, and side wings 2001 for some comfort during use. An extra bend option, useful for getting access to ring pulls of cans with high lips, is shown at 2003 in FIG. 20e. That figure also shows an optional curved slot 2002 (side view).

FIG. 21a shows yet another dual-purpose tool, similar to that of FIG. 8 but also having a flattened portion 2101 in the handle including a slot 2105 for engagement with a beverage can type ring-pull. Conveniently, inclusion of this device provides a pair of finger places 2102 and 2102′. Again, a rivet notch 1901 is provided in the lower edge. FIG. 21b shows a section through the flattened portion A-A′ of 2101 and includes a section through a slightly curved slot 2105 and includes the external edge 2103 and the internal edge 2104. A generally rounded profile is preferred, because this end of the tool is against the user's hand when the other kind of ring pull is being removed.

Single-function tools according to this example simply provide for beverage can tab opening functions, without also including the apparatus for breaking the seals of food-type cans (those with the larger ring pulls intended to hold a finger). FIGS. 17 and 18 can be read as showing these tools.

In the prototype example shown in FIG. 1, the entire body of the tool was shaped from a slab of a durable plastics material (polypropylene). In order to reduce expense, the tool may be injection-moulded or fabricated in another mass-adapted way. The tool of FIGS. 6, 7, and 8 is a production run injection moulded tool, made in polycarbonate in a variety of colours. Although the seal-breaking edge is adequately strong when fabricated from a variety of plastics, it may be justified to use a metal or a strong plastics insert in a moulded tool, while the remainder of the tool can be a virgin plastic, or even a recycled plastics material. Many plastics, plastic alloys, and composites are suitable materials for use. If one foregoes the advantages of injection moulding, other materials may be used (apart from plastics) such as metal, wood, wood-based composites, bone, or stone. Metal versions may be made by a casting process, or pressure die-casting, milling from the solid, or other methods as are known in the art, especially involving sheet metal.

The tool may also be provided with other convenient openers such as one for removal of crown bottle caps.

It would be possible for a manufacturer to make a container having a ring pull of different dimensions, then sell the container with an adapted tool according to the invention, so that people come to prefer to return to that manufacturer's products. Tools for use in the commercial food industry (bars, restaurants, hotels, etc) may be made entirely of a hard material acceptable to certification authorities, such as certain grades of stainless steel. This permits better wear characteristics and easy and repeated cleaning to the high standard required. However plastics will be acceptable in most industries.

Other versions of the tool can be mounted on a wall so that the user only has to hold and move the body of the tin in relation to the working area of the tool.

Another way to make a tool according to the invention is to stamp or otherwise form it from a metal sheet, such as 2 to 3 mm steel sheet, and optionally plate the steel to minimise corrosion, and extend its life. Other materials may be used according to the dictates of convenience and economics, as is well known in the art. Where a relatively high protrusion is called for, such as in providing the raised ramp and land, this could be provided by cutting through the metal at the rear so that the ramp resembles a raised tongue. Again this tool has a similar layout at the “business end” such as the provision of leading edges and a moat about the raised ramp.

Another way to provide a beverage tab slot which holds the tab is to construct a taper within the slot (wider at the tab-accepting or open end) so that the tab becomes jammed in place after a sufficient length has been pushed into the slot.

This approach is dependent on tab thickness but is easy to mould by an injection moulding technique, using a tapered tongue.

Another way to provide a beverage tab slot which grips the tab is to connect a taper within the slot (wider at the tab-accepting or open end) so that this tab becomes jammed in place after a sufficient length has been pushed into the slot.

This approach is dependent on tab thickness but is easy to mould by an injection moulding technique, using a tapered tongue.

The tool of the invention renders the operation of removing a ring pull seal much easier than previously, and the tool is especially convenient for people with disabilities or degenerative diseases, including neuromuscular diseases. Persons with soft or ornamental (e.g. long, painted) fingernails need not risk damage to their nails.

Any person (with any length of finger nail) can find some ring pulls difficult—some behave as if they are spring-loaded to lie firmly against the lid surface. A knife or similar metal device generally had to be used to prise the ring pull away from the surface and this could cause serious injury.

The tool also facilitates the ease of frequent use of ring pulls such as by workers in the service industry. The tool is compatible with construction of a mechanised version of a ring pull type can opener.

The tool is a useful promotional accessory to aid sales of a commodity.

Finally, it will be understood that the scope of this invention as described and/or illustrated within this provisional specification is not limited to the preferred embodiments described herein for illustrative purposes. Those skilled in the art will appreciate that various modifications, additions, and substitutions are possible without departing from the scope of the invention.

1. A can opening device comprising:
a base having a wedge portion at one end and a handle at an opposite end;
a ring pull gripping device mounted on the wedge portion and arranged to grip the ring pull when the wedge portion is inserted beneath the ring pull.

2. A device as claimed in claim 1, wherein the one end of the base defines a first pivot point about which the device can be pivoted to lift the ring pull.

3. A device as claimed in claim 1 or 2, wherein the base defines a raised side wall around the wedge portion for locating the ring pull after the wedge portion is inserted beneath the ring pull.

4. A device as claimed in any preceding claim, wherein the handle extends upwardly from the base.

5. A device as claimed in claim 4, wherein the handle extends at 30-60 degrees to the base.

6. A device as claimed in any preceding claim, wherein the gripping device comprises a latch member projecting upwardly from the wedge portion.

7. A device as claimed in claim 6, wherein the latch member has a ramp surface at its front, having regard to the direction of insertion of the wedge portion beneath the ring pull, and a recess at is back.

8. A device as claimed in claim 6 or 7, wherein the height of the latch member above the base is such that the ring pull is elastically deformed for self-engagement with the latch member when the wedge portion is inserted beneath the ring pull.

9. A device as claimed in claim 8, wherein the latch member extends to approximately 1 cm above the base.

10. A device as claimed in any preceding claim, wherein the opposite end of the base defines a second pivot point about which the device can be pivoted to lift the lid attached to the ring pull.

11. A device as claimed in any preceding claim, wherein the ring pull gripping device is for gripping a first size of ring pull, and wherein a second engagement device is provided for engaging with a second size of ring pull.

12. A device as claimed in claim 11, wherein the second engagement device comprises a slot for receiving the handle of the second size of ring pull.

13. A device as claimed in claim 12, wherein the slot is provided in the handle.

14. A device as claimed in claim 12, wherein the slot is provided in the wedge portion.

15. A device as claimed in any preceding claim, comprising a unitary moulded article.

16. A device as claimed in claim 15, comprising a moulded plastics article.
